(19) United States
(12) Patent Application Publication
(10) Pub. No.: US 2016/0320902 A1
(43) Pub. Date: Nov. 3, 2016

(54) TOUCH SENSITIVE PANEL, SCREEN AND ELECTRONIC DEVICE

(71) Applicant: EGALAX_EMPIA TECHNOLOGY INC., Taipei City (TW)

(72) Inventor: CHIN-FU CHANG, TAIPEI CITY (TW)

(21) Appl. No.: 15/140,729

(22) Filed: Apr. 28, 2016

Related U.S. Application Data
(60) Provisional application No. 62/153,893, filed on Apr. 28, 2015.

(30) Foreign Application Priority Data
Dec. 31, 2015 (TW) 104144645

(51) Int. Cl. G06F 3/041; G06F 3/044

(52) U.S. Cl. CPC G06F 3/0416; G06F 3/0414; G06F 3/044; G06F 2203/04103; G06F 2203/04111; G06F 2203/04107

(57) ABSTRACT

This invention provides a touch sensitive panel, comprising: a driving electrode layer including multiple driving electrodes being parallel to a first axis; a sensing electrode layer including multiple sensing electrodes being parallel to a second axis; and an elastic body layer sandwiched between the driving electrode layer and the sensing electrode layer, wherein an area occupied by the multiple driving electrodes is larger than 80% of an area of the touch sensitive panel.

### CROSS REFERENCE TO RELATED APPLICATIONS

This application claims priority to U.S. patent application. Ser. No. 62/153,893, filed on Apr. 28, 2015, and Taiwan patent application No. 104144645, filed on Dec. 31, 2015, the disclosures of which are incorporated herein by reference.

### BACKGROUND OF THE INVENTION

1. Field of the Invention

The present invention relates to a touch sensitive technology, and more particularly, to a touch sensitive technology being relative to pressure.

2. Description of the Prior Art

The design principles of a capacitive touch sensitive panel or screen in the prior art include placing multiple sensing electrodes arranged in parallel along a first direction, and placing multiple driving electrodes arranged in parallel along a second direction under the sensing electrodes. That is, the sensing electrodes are positioned closer to an external object, and the driving electrodes are positioned away from the external object and closer to a screen under them. In performing sensing, at least one of the driving electrodes is in turn caused to transmit a driving signal, with the other driving electrodes being grounded, and then the variations in current induced by the sensing electrodes are measured. This measurement can be used to detect an external object that approximates to or touches on the touch sensitive panel or screen, and to calculate the external object's position over/on the touch sensitive panel or screen.

Advantages of the design in the prior art include that when a large amount of electromagnetic interference (EMI) is emitted from the screen under the sensing and driving electrodes, most of the grounded driving electrodes work as a shielding layer to shield the interference with the sensing electrodes due to the electromagnetic waves being grounded by the grounded driving electrodes. In addition, when an external conductive object approaches but hasn't touched the touch sensitive panel/screen, a conducting loop of capacitive inducing may be formed between the object and the sensing electrode(s), allowing the touch sensitive processing device to detect the object hovering over the touch sensitive panel/screen.

In some applications, however, it may not be desired for the capacitive touch sensitive panel/screen to detect the hovering object, but only the function of detecting the object touching or pressing the touch sensitive panel/screen is desired. Accordingly, there are serious needs for a kind of touch sensitive panel/screen that can detect only the object touching or pressing on it, and for a corresponding detecting method.

### SUMMARY OF THE INVENTION

In some embodiments, the present invention provides a touch sensitive panel, comprising: a driving electrode layer including multiple driving electrodes being parallel to a first axis; a sensing electrode layer including multiple sensing electrodes being parallel to a second axis; and an elastic body layer sandwiched between the driving electrode layer and the sensing electrode layer, wherein an area occupied by the multiple driving electrodes is larger than 80% of an area of the touch sensitive panel.

In some examples of the described embodiments, the driving electrode layer further includes multiple dummy electrodes. Wherein, an area occupied by the multiple driving electrodes and the dummy electrodes is larger than 80% of an area of the touch sensitive panel. In one variation, the multiple driving electrodes, the multiple sensing electrodes and the multiple dummy electrodes are all connected to a touch sensitive processing device.

In some examples of the described embodiments, the elastic body layer at least includes one of the following structures: a homogeneous elastic body layer; a cylinder; an elliptical cylinder; a lump; a trapezoid lump; a round ramp; an oval ramp; and a wavy curve elastic body layer.

In some examples of the described embodiments, the elastic body layer includes multiple intervals and/or holes.

In some examples of the described embodiments, the touch sensitive panel further includes a transparent protection layer being adjacent to the driving electrode layer.

In some embodiments, the present invention provides a touch sensitive screen, comprising: a transparent protection layer; a screen; and a touch sensitive panel sandwiched between the transparent protection layer and the screen. The touch sensitive panel comprises a driving electrode layer including multiple driving electrodes being parallel to a first axis; a sensing electrode layer including multiple sensing electrodes being parallel to a second axis; and an elastic body layer sandwiched between the driving electrode layer and the sensing electrode layer, wherein an area occupied by the multiple driving electrodes is larger than 80% of an area of the touch sensitive panel.

In some embodiments, the present invention provides a touch sensitive electronic device including a touch sensitive screen. The touch sensitive screen includes a transparent protection layer, a screen, and a touch sensitive panel sandwiched between the transparent protection layer and the screen. The touch sensitive panel comprises a driving electrode layer including multiple driving electrodes being parallel to a first axis; a sensing electrode layer including multiple sensing electrodes being parallel to a second axis; and an elastic body layer sandwiched between the driving electrode layer and the sensing electrode layer, wherein an area occupied by the multiple driving electrodes is larger than 80% of an area of the touch sensitive panel. The touch sensitive electronic device further includes a touch sensitive processing device configured to connect the multiple driving electrodes and the multiple sensing electrodes.

One of the aspects of the present invention is that when the touch sensitive processing device detects the sensed signal magnitude from some sensing electrodes increasing, the touch sensitive processing device can then determine the position or location of an external object touching on a touch sensitive panel according to the sensed signal magnitude variation, and also determine a pressure of the external object touching on the touch sensitive panel.

One of the aspects of the present invention is that various techniques previously proposed by the applicant can well be used to filter out the electromagnetic interference emitted from a screen under a touch sensitive panel. For example, the difference between the sensed signal respectively of two adjacent sensing electrodes can be calculated, or the difference between two calculated instances of difference between the sensed signal respectively of the two adjacent sensing electrodes can be calculated. This difference between two calculated difference instances is called dual-difference. The applicant had filed several patents which mentioned how to use the difference and/or dual-difference to calculate the position of the external object, the explanations of which techniques are not repeated in detailed again herein.

One of the aspects of the present invention is that a conductive fluid resting on a surface of a touch sensitive panel will not be wrongly treated as a touch event for controlling.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 illustrates a structure diagram for a touch sensitive panel 100 according to one embodiment of the present invention;

FIG. 2A illustrates a sectional view for an external object 210 approaching a touch sensitive panel 100 according to one embodiment of the present invention;

FIG. 2B illustrates a sectional view for an external object 210 touching a touch sensitive panel 100 according to one embodiment of the present invention;

FIG. 3 illustrates a sensed signal for a sensing electrode according to one embodiment of the present invention; and

FIGS. 4(a) to (d) illustrate some sectional views for an elastic body layer 120 according to some embodiments of the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

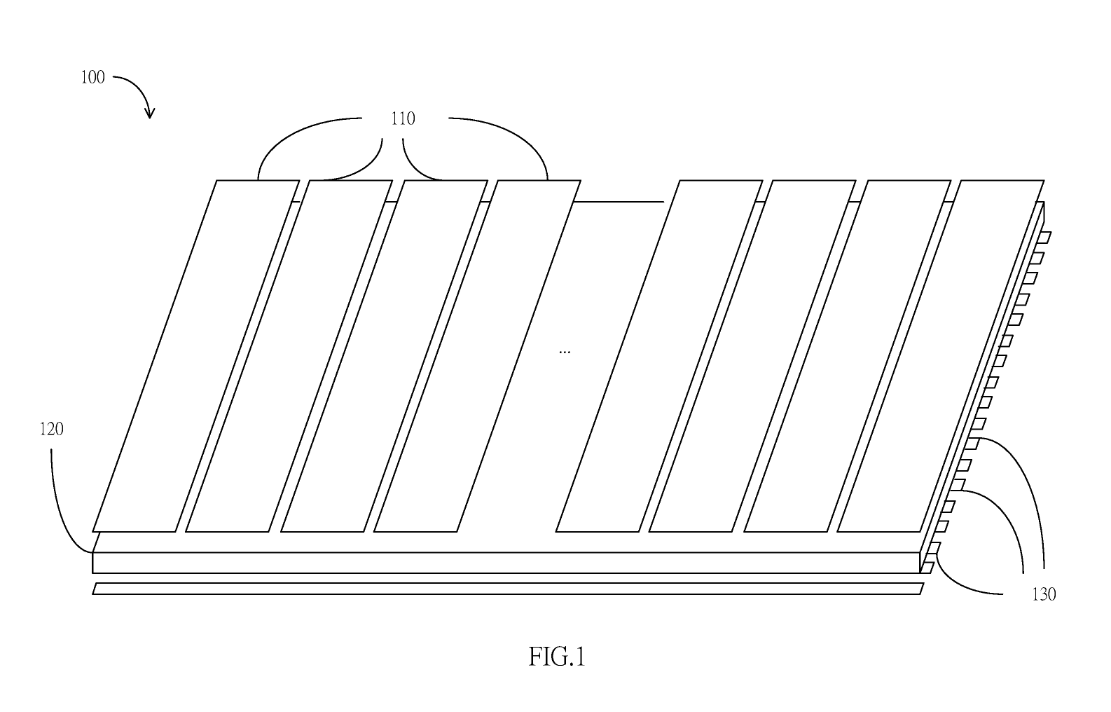

Referring to FIG. 1, a structure diagram for a touch sensitive panel 100 according to an embodiment of the present invention is illustrated. In this application, for the convenience of explanation, the term “touch sensitive panel” is used to refer to a touch sensitive screen including a bottom screen and/or a touch sensitive panel without a bottom screen. On the touch sensitive panel, a transparent protection layer may further be included for preventing the touch sensitive panel from being scratched by an external object. In FIG. 1, the touch sensitive panel 100 includes multiple driving electrodes 110 placed above, an elastic body layer 120 placed at the middle, and multiple sensing electrodes 130 placed below. The multiple driving electrodes 110 and the multiple sensing electrodes 130 are all connected to a touch sensitive processing device.

The plurality of driving electrodes 110 and the plurality of sensing electrodes 130 may include transparent conductive material(s), such as pieces of indium tin oxide (ITO) respectively formed on a transparent substrate. As shown in FIG. 1, the plurality of driving electrodes 110 may each be in the shape of a long bar, or in one of other shapes. An ordinary skilled in the art can appreciate that there are different kinds of shapes of the driving electrode 110 and the sensing electrode 130, respectively, and this invention is not limited to any particular shape for each of driving electrodes 110 and sensing electrodes 130.

It should be noted that one of the features in this invention is that the plurality of driving electrodes 110 cover most of the whole area of the touch sensitive panel 100 supporting the plurality of driving electrodes 110. In other words, the exposed area of the plurality of driving electrodes 110 covers at least a percentage of the whole area of the touch sensitive panel 100 supporting the driving electrodes 110, such as for example 80%, 90%, or even over 95%.

In this invention, the plurality of driving electrodes 110 are used to shield or prevent an external object from capacitively coupling or inducing a current with the plurality of sensing electrodes 130 positioned below. Hence, when an external object approaches but hasn't touched the touch sensitive panel, the object will not capacitively couple or induce a current with the plurality of sensing electrodes 130.

In some embodiments, the touch sensitive panel 100 may further include multiple dummy electrodes positioned in the same layer with the plurality of driving electrodes 110. These dummy electrodes not shown in FIG. 1 may be disposed between the plurality of driving electrodes 110, such that the total exposed area of the plurality of driving electrodes 110 and the plurality of dummy electrodes covers at least a percentage of the whole area of the touch sensitive panel 100 supporting them, such as for example 80%, 90%, or even over 95%. And these dummy electrodes can similarly be used to shield or prevent an external object from coupling or inducing a current with the plurality of sensing electrodes 130. In one embodiment, for example, these dummy electrodes are grounded or connected to a direct current (DC) potential, and particularly, through the touch sensitive processing device. In another embodiment, these dummy electrodes are not grounded or connected to any circuit or component. In a best mode embodiment of this invention, the total exposed area of the grounded electrodes (such as the driving electrodes or the driving electrodes with dummy electrodes) covers over at least 90% of the whole area of the touch sensitive panel supporting them.

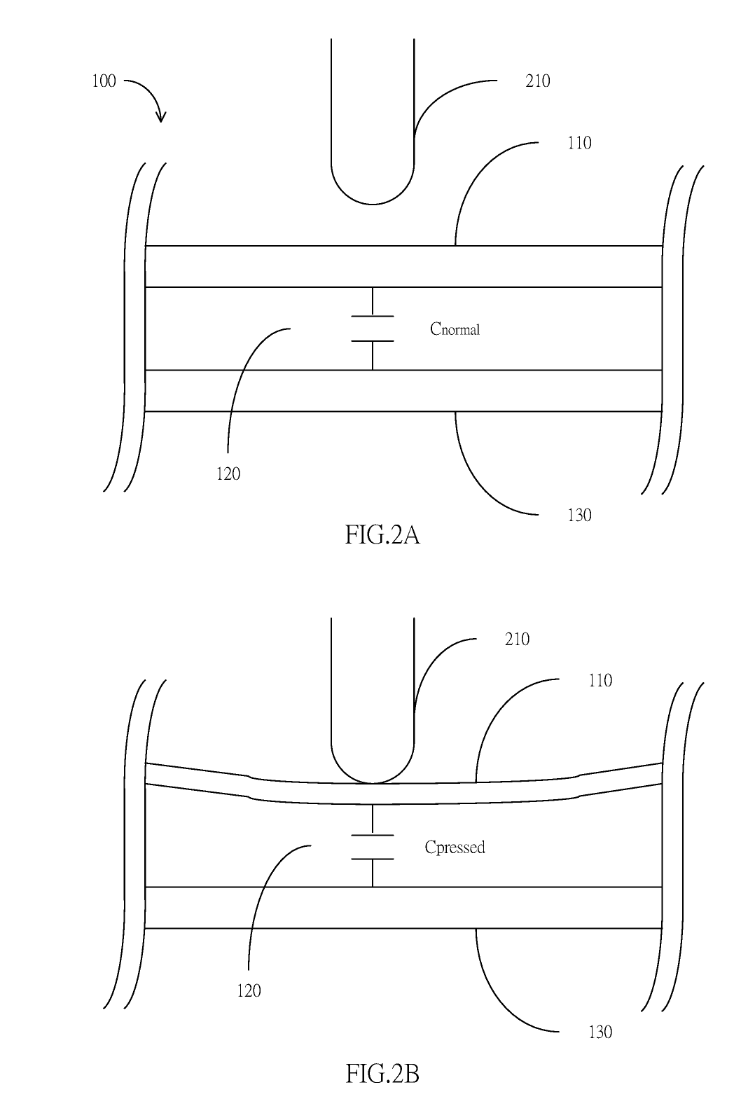

Referring to FIG. 2A, a sectional view for an external object 210 approaching a touch sensitive panel 100 according to an embodiment of the present invention is illustrated. In FIG. 2A, since the external object has not touched the touch sensitive panel 100, the elastic body layer 120 mentioned above is not bearing any pressure, and its elastic force maintain a certain normal distance between the driving electrodes 110 above and the sensing electrodes 130 below. With this normal distance, the capacitor between the driving electrodes 110 and the sensing electrodes 130 has a (normal) capacitance Cₙₒᵣₘₐₗ.

Assuming the external object 210 is connected to ground, a capacitive coupling or inducing loop is thus formed between the driving electrodes 110 and the external object 210. Then some of the electrical energy of a driving signal emitted by the driving electrodes 110 is connected or released to ground through the external object 210. In this case, the driving signal that is sensed by the sensing electrodes 130 may be weaker. On the other hand, assuming the external object 210 is not connected to ground, a capacitive coupling or inducing loop is then not formed between the driving electrodes 110 and the external object 210. Hence, the driving signal that is sensed by the sensing electrode 130 is not changed.

When an external conductive object is approaching a traditional capacitive touch sensitive panel, the driving signal that is sensed by the sensing electrodes will increase due to the approaching external conductive object. Accordingly, it can be known that when an external object is approaching, the driving signal that is sensed by the sensing electrodes according to the embodiments of this invention will be maintained or be weaker. But when an external object is approaching, the driving signal that is sensed by the sensing electrodes of a traditional touch sensitive panel will be maintained or be stronger.

Referring to FIG. 2B, a sectional view for an external object 210 touching a touch sensitive panel 100 according to an embodiment of the present invention is illustrated. In FIG. 2B, since the external object 210 has touched the touch sensitive panel 100, the elastic body layer 120 mentioned above is bearing pressure and thus deformed downward. During deformation, the elastic force of the elastic body layer 120 cannot counteract the pressure from the external object 210, and hence a certain normal distance between the driving electrodes 110 above and the sensing electrodes 130 below cannot be maintained. When the distance between the driving electrodes 110 and the sensing electrodes 130 reduced in this case, the capacitor between the driving electrodes 110 and the sensing electrodes 130 has a pressed capacitance C_{pressed}.

Since the total surface areas of the driving electrodes 110 and the sensing electrodes 130 are not changed, the normal capacitance Cₙₒᵣₘₐₗ is smaller than the pressed capacitance C_{pressed} caused by the reduced distance between the driving electrodes 110 and the sensing electrodes 130. In other words, in the case of being pressed or bearing pressure, the capacitive coupling or inducing between the driving electrodes 110 and the sensing electrodes 130 increases, causing the driving signal that is sensed by the sensing electrodes 130 to increase in magnitude accordingly. When the touch sensitive processing device detects that the sensed signal magnitude from some sensing electrodes 130 has increased, the touch sensitive processing device can then determine the position or location of the external object 210 touching on the touch sensitive panel 100 according to the sensed signal magnitude variation, and also determine the pressure of the external object 210 touching on the touch sensitive panel 100.

On the other hand, it should be explained that if the touch sensitive panel according to the embodiments of this invention includes a bottom screen, the plurality of sensing electrodes 130 will be interfered by the electromagnetic waves emitted from the screen. Electromagnetic interference emitted from the screen can be regarded as homogeneous noise, or at least has almost equal impacting on each of two adjacent sensing electrodes 130. Regardless of whether being interfered by electromagnetic waves emitted from the screen, various techniques previously proposed by the applicant can well be used to filter out the electromagnetic interference mentioned above. For example, the difference between the sensed signal respectively of two adjacent sensing electrodes 130 can be calculated, or the difference between two calculated instances of difference between the sensed signal respectively of the two adjacent sensing electrodes 130 can be calculated. This difference between two calculated difference instances is called dual-difference. The applicant had filed many patents which mentioned how to use the difference and/or dual-difference to calculate the position of the external object, the explanations of which techniques are not repeated in detailed again herein.

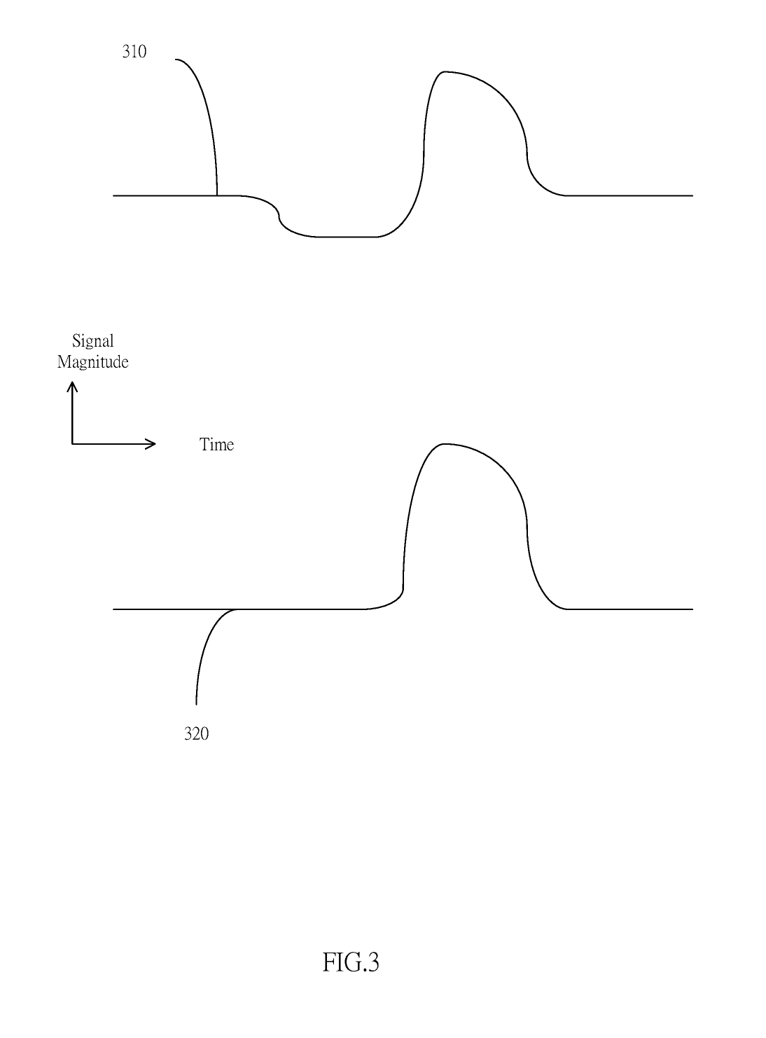

Referring to FIG. 3 a sensed signal for a sensing electrode according to an embodiment of the present invention is illustrated. FIG. 3 includes two curves 310 and 320, with a horizontal axis being time and a vertical axis being the sensed signal magnitude. Referring to the curve 310, when an external object is slowly approaching the touch sensitive panel, the corresponding sensing electrode(s) will initially sense a smaller or normal reference amount of signal. Then upon the external object pressing the touch sensitive panel, the sensed signal amount will be larger than the normal reference amount.

Referring to the curve 320, when the external object is a non-conductive object not connected to ground, or when the external object is conductive and quickly touches and presses the touch sensitive panel, the corresponding sensing electrode(s) will sense the sensed signal amount larger than the normal reference amount only upon the external object touching the touch sensitive panel.

It can be known from the two curves 310 and 320 that the touch sensitive processing device only needs to process the sensed signal amount larger than the normal reference amount, in order to filter out any touch event that is triggered by an external object that has approached but not touched the touch sensitive panel, regardless of whether the external object is connected to ground or not.

Another advantage provided by the embodiments of the present invention is that a conductive fluid resting on a surface of a touch sensitive panel will not be wrongly treated as a touch event for controlling. Sometimes, under certain situations, the touch sensitive panel may need to be exposed and used in critical or rigorous environments. For example, in one of such situations, sea water with pretty conductivity resting on the touch sensitive panel, and wrongly treating this event as a touch event may cause the touch sensitive panel to fail to operate normally. However, in this invention, since the weight of a conductive fluid is usually light and thus can exert only a tiny pressure on the touch sensitive panel, the conductive fluid resting on the touch sensitive panel has only a very limited impact on the normal capacitance Cₙₒᵣₘₐₗ described above. And further, since the plurality of driving electrodes can prevent the capacitive coupling or inducing between the conductive fluid and the sensing electrode(s), the conductive fluid resting on a surface of the touch sensitive panel will not be wrongly treated as an external object.

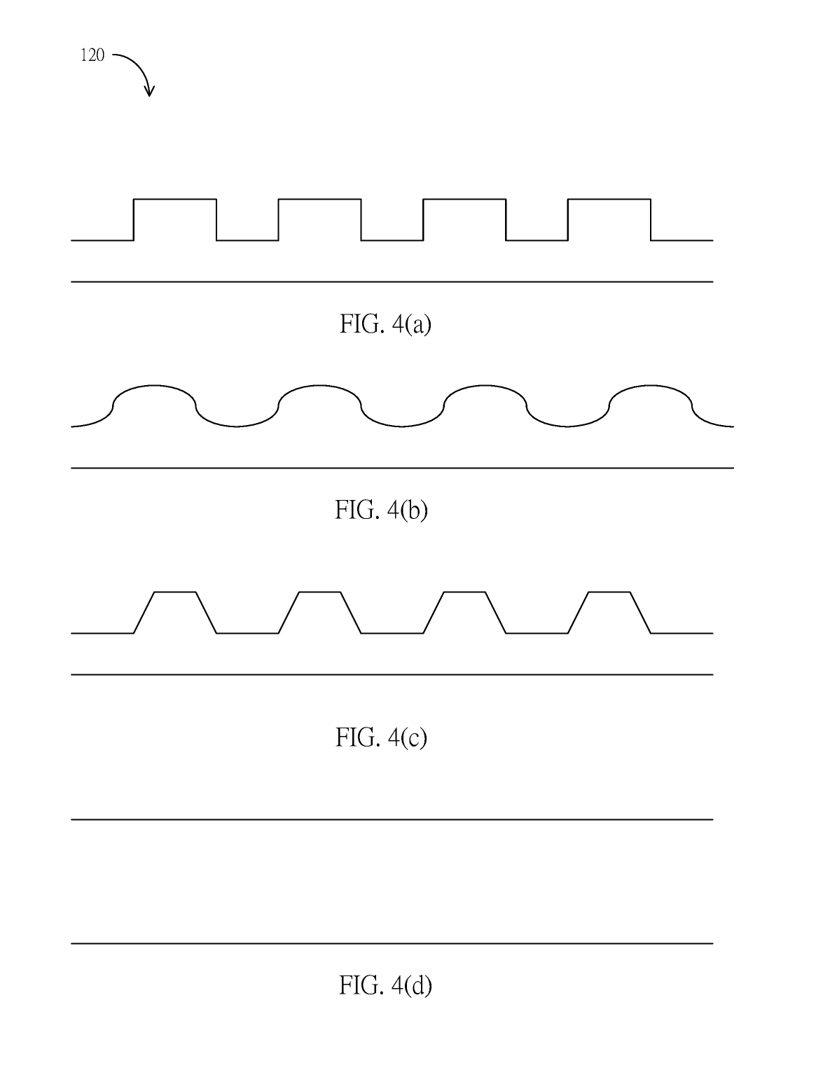

Referring to FIGS. 4(a) to (d), some sectional views for an elastic body layer 120 according to some embodiments of the present invention are illustrated. FIGS. 4(a) to (d) include 4 examples of the sectional views to the elastic body layer 120, wherein an example FIG. 4(d) shows a sectional view for a simplest homogeneous elastic body layer as shown in FIG. 1. An example FIG. 4(a) illustrates an elastic body layer including two layers, a bottom layer and a top layer having multiple projections or bulges. The bulges may each be in the shape of, such as a cylinder, an elliptical cylinder, or a lump, or the shapes of the bulges may include, for example, the shape of a cylinder and the shape of a lump. An example FIG. 4(b) also illustrates an elastic body layer including a bottom layer and a top layer having multiple bulges. But its difference from the example FIG. 4(a) is that the bulges in the example FIG. 4(b) have upper surfaces which are smooth and rounded relative to that of the bulges in the example FIG. 4(a), and therefore the upper edge of the sectional view in the example FIG. 4(b) is a wavy curve. An example FIG. 4(c) also illustrates an elastic body layer including a bottom and a top layer having multiple bulges, wherein the bulges may each be in the shape of, such as a trapezoid, a round ramp, or an oval ramp, or may include, for example, a combination of at least two of the three shapes.

Briefly, the elastic body layer 120 includes a top layer having the bulges on the elastic body layer 120's bottom layer. Therefore, gaps or spaces between the bulges referred to as the elastic body layer 120 having multiple intervals and/or holes make the elastic body layer 120 more susceptible to being deformed due to bearing pressure, which deformation causes change in the described capacitance. And of course, the uses of the elastic body layer 120 also include making the touch sensitive panel return to its original shape when not bearing any pressure, thereby making the capacitance return to its normal value.

In some embodiments, the present invention provides a touch sensitive panel, comprising: a driving electrode layer including multiple driving electrodes being parallel to a first axis; a sensing electrode layer including multiple sensing electrodes being parallel to a second axis; and an elastic body layer sandwiched between the driving electrode layer and the sensing electrode layer, wherein an area occupied by the multiple driving electrodes is larger than 80% of an area of the touch sensitive panel.

In some examples of the described embodiments, the driving electrode layer further includes multiple dummy electrodes. Wherein, an area occupied by the multiple driving electrodes and the dummy electrodes is larger than 80% of an area of the touch sensitive panel. In one variation, the dummy electrodes are connected to a DC potential. In another variation, the multiple driving electrodes, the multiple sensing electrodes and the multiple dummy electrodes are all connected to a touch sensitive processing device.

In some examples of the described embodiments, the elastic body layer at least includes one of the following structures: a homogeneous elastic body layer; a cylinder; an elliptical cylinder; a lump; a trapezoid lump; a round ramp; an oval ramp; and a wavy curve elastic body layer.

In some examples of the described embodiments, the elastic body layer includes multiple intervals and/or holes.

In some examples of the described embodiments, the touch sensitive panel further includes a transparent protection layer being adjacent to the driving electrode layer.

In some embodiments, the present invention provides a touch sensitive screen, comprising: a transparent protection layer; a screen; and a touch sensitive panel sandwiched between the transparent protection layer and the screen. The touch sensitive panel comprises a driving electrode layer including multiple driving electrodes being parallel to a first axis; a sensing electrode layer including multiple sensing electrodes being parallel to a second axis; and an elastic body layer sandwiched between the driving electrode layer and the sensing electrode layer, wherein an area occupied by the multiple driving electrodes is larger than 80% of an area of the touch sensitive panel.

In some examples of the described embodiments, the driving electrode layer further includes multiple dummy electrodes. Wherein, an area occupied by the multiple driving electrodes and the dummy electrodes is larger than 80% of an area of the touch sensitive panel. In one variation, the dummy electrodes are connected to a DC potential. In another variation, the multiple driving electrodes, the multiple sensing electrodes and the multiple dummy electrodes are all connected to a touch sensitive processing device.

In some examples of the described embodiments, the elastic body layer at least includes one of the following structures: a homogeneous elastic body layer; a cylinder; an elliptical cylinder; a lump; a trapezoid lump; a round ramp; an oval ramp; and a wavy curve elastic body layer.

In some examples of the described embodiments, the elastic body layer includes multiple intervals and/or holes.

In some embodiments, the present invention provides a touch sensitive electronic device including a touch sensitive screen. The touch sensitive screen includes a transparent protection layer, a screen, and a touch sensitive panel sandwiched between the transparent protection layer and the screen. The touch sensitive panel comprises a driving electrode layer including multiple driving electrodes being parallel to a first axis; a sensing electrode layer including multiple sensing electrodes being parallel to a second axis; and an elastic body layer sandwiched between the driving electrode layer and the sensing electrode layer, wherein an area occupied by the multiple driving electrodes is larger than 80% of an area of the touch sensitive panel. The touch sensitive electronic device further includes a touch sensitive processing device configured to connect the multiple driving electrodes and the multiple sensing electrodes.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A touch sensitive panel, comprising:
a driving electrode layer, including a plurality of driving electrodes being parallel to a first axis;
a sensing electrode layer, including a plurality of sensing electrodes being parallel to a second axis; and
an elastic body layer sandwiched between the driving electrode layer and the sensing electrode layer,
wherein an area occupied by the plurality of driving electrodes is larger than 80% of an area of the touch sensitive panel.

2. The touch sensitive panel of claim 1, wherein the driving electrode layer further includes a plurality of dummy electrodes, wherein an area occupied by the plurality of driving electrodes and the plurality of dummy electrodes is larger than 80% of an area of the touch sensitive panel.

3. The touch sensitive panel of claim 2, wherein the plurality of dummy electrodes are connected to a DC potential.

4. The touch sensitive panel of claim 2, wherein the plurality of driving electrodes, the plurality of sensing electrodes, and the plurality of dummy electrodes are all connected to a touch sensitive processing device.

5. The touch sensitive panel of claim 1, wherein the elastic body layer at least includes one of the following structures: a homogeneous elastic body layer; a cylinder; an elliptical cylinder; a lump; a trapezoid lump; a round ramp; an oval ramp; and a wavy curve elastic body layer.

6. The touch sensitive panel of claim 1, wherein the elastic body layer includes a plurality of intervals and/or holes.

7. The touch sensitive panel of claim 1, further comprising:
a transparent protection layer being adjacent to the driving electrode layer.

8. A touch sensitive screen, comprising:
a transparent protection layer;
a screen; and
a touch sensitive panel sandwiched between the transparent protection layer and the screen, the touch sensitive panel comprising:
a driving electrode layer, including a plurality of driving electrodes being parallel to a first axis;
a sensing electrode layer, including a plurality of sensing electrodes being parallel to a second axis; and
an elastic body layer sandwiched between the driving electrode layer and the sensing electrode layer,
wherein an area occupied by the plurality of driving electrodes is larger than 80% of an area of the touch sensitive panel.

9. A touch sensitive electronic device, comprising:
a touch sensitive screen, comprising:
a transparent protection layer;
a screen; and
a touch sensitive panel sandwiched between the transparent protection layer and the screen, the touch sensitive panel comprising:
a driving electrode layer, including a plurality of driving electrodes being parallel to a first axis;
a sensing electrode layer, including a plurality of sensing electrodes being parallel to a second axis; and
an elastic body layer sandwiched between the driving electrode layer and the sensing electrode layer,
wherein an area occupied by the plurality of driving electrodes is larger than 80% of an area of the touch sensitive panel; and
a touch sensitive processing device, configured to connect the plurality of driving electrodes and the plurality of sensing electrodes.
